(19) United States
(12) Patent Application Publication
(10) Pub. No.: US 2018/0093209 A1
(43) Pub. Date: Apr. 5, 2018

(54) FUEL FILTER

(71) Applicant: Kyosan Denki Co., Ltd., Koga-city, Ibaraki-pref. (JP)

(72) Inventors: Takafumi KATO, Koga-city (JP); Toshiyuki YONEMOTO, Koga-city (JP)

(21) Appl. No.: 15/566,875

(22) PCT Filed: Feb. 9, 2016
(86) PCT No.: PCT/JP2016/000648

§ 371 Date: Oct. 16, 2017

(30) Foreign Application Priority Data
Apr. 24, 2015 (JP) 2015-089672

(51) Int. Cl. B01D 29/15; B01D 35/00; B60K 15/04

(52) U.S. Cl. CPC B01D 29/15; B60K 2015/03236; B60K 15/04; B01D 35/005

(57) ABSTRACT

A fuel filter has a case. The case has a cup and cap. The cup and the cap can be detached and attached by an engaging mechanism. The case has an air passage for discharging air. The air passage has an annular capturing passage formed between the cup and the cap. A plurality of through holes are formed on the cap. The plurality of through holes are dispersively arranged along the capturing passage. Air flows into the capturing passage through the through hole. Air reaches to a lead-out passage through the capturing passage. Air is discharged through the outlet passage from the lead-out passage.

### CROSS REFERENCE TO RELATED APPLICATIONS

This application is based on Japanese Patent Application No. 2015-89672 filed on Apr. 24, 2015, the disclosure of which is incorporated herein by reference.

### TECHNICAL FIELD The disclosure in this description relates to a fuel filter which filters a fuel.

### BACKGROUND

Patent Literature 1 discloses a fuel filter. The fuel filter discloses a passage for discharging air. A case of the fuel filter has a cup and a cap. The air discharging passage is disposed on the cup. The air discharging passage is communicated with an inside of the case at an upper portion of the case.

### CITATION LIST

### Patent Literature

Patent Literature 1: JP2012-154223A

### SUMMARY

With the structure of the conventional technique, the air discharging passage and the inside of the case are communicated at only one position. Therefore, air can be discharged only at a specific position of an upper portion of the case. In the above viewpoint, or in the other viewpoint not mentioned above, further improvement of a fuel filter is still demanded.

It is an object of the present disclosure to provide a fuel filter which can discharge air from wide range of the inside of the case.

In order to achieve each object, a plurality of embodiments disclosed in this specification use technical measures different each other. The symbols in the parenthesis indicated in the above section and the claim merely show correspondence relations with concrete elements described in embodiments later mentioned as one example, and are not intended to limit the technical scope of this disclosure.

One disclosure provides a fuel filter. The fuel filter comprises an element (63) which filters a fuel; and a case (31) which accommodates the element, and defines and forms a passage for flowing the fuel to pass through the element. The case (31) is separatable into a cup (32) and a cap (33) to exchange the element. The case forms a capturing passage (72) which extends in a circumferential direction along an upper portion of the case, a plurality of through holes (77, 377) which are dispersively arranged along the capturing passage and communicates an inside of the case and the capturing passage, and a lead-out passage (78) which extends out from a part of the capturing passage.

The capturing passage extends in the circumferential direction along the upper portion of the case. In addition, the capturing passage communicates with the inside of the case through the plurality of through holes arranged dispersively. Therefore, air within the case can flow into the capturing passage, from a wide range, by passing through the plurality of through holes. Since the capturing passage extends in the circumferential direction, air flows along the circumferential direction in the capturing passage, and reaches the lead-out passage. As a result, air can be caught from the wide range and can be discharged to the lead-out passage.

### BRIEF DESCRIPTION OF THE DRAWINGS

FIG. 1 is a block diagram of a fuel supply device according to a first embodiment;

FIG. 2 is a cross sectional view of a filter assembly;

FIG. 3 is a partial cross sectional view on a line III-III in FIG. 2;

FIG. 4 is a perspective view showing a cap of the filter assembly;

FIG. 5 is a cross sectional view on a line V-V in FIG. 4;

FIG. 6 is a cross sectional view of a cap according to a second embodiment; and

FIG. 7 is a cross sectional view of a cap according to a third embodiment.

### DETAILED DESCRIPTION

A plurality of embodiments are described referring to the drawings. In the embodiments, portions, which may be corresponded and/or associated in functionally and/or structurally, may be indicated by the same reference symbols or reference symbols which merely differs at hundred or above digits. Description of other embodiment can be referred to for corresponding portions and/or associated portions.

### First Embodiment

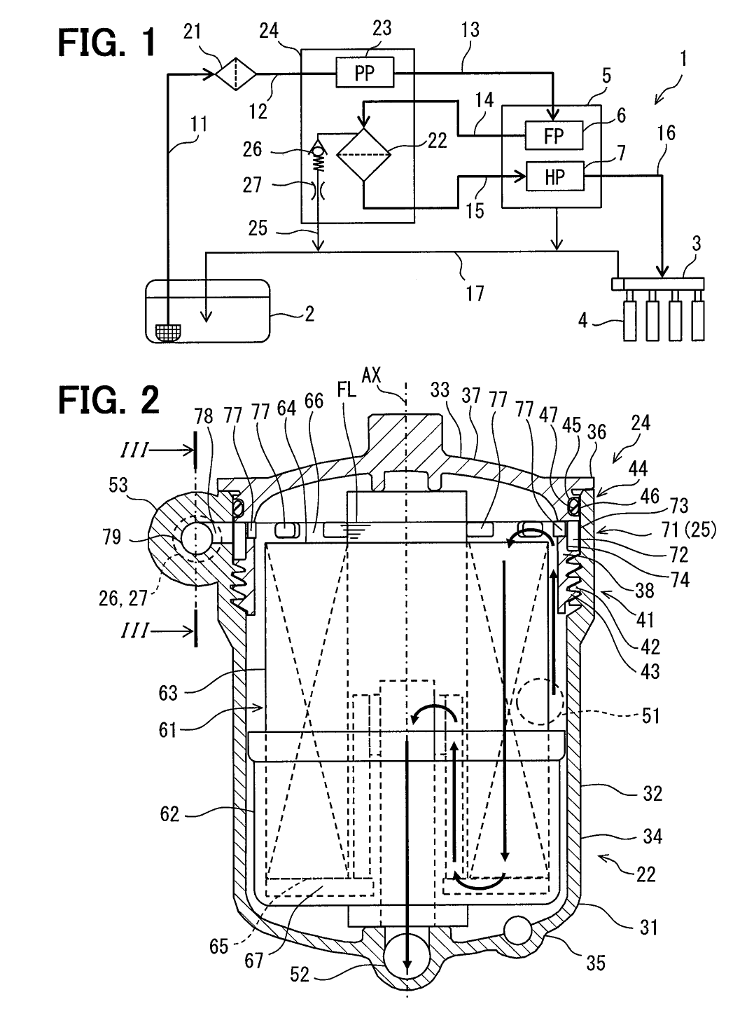

In FIG. 1, a fuel supply device 1 supplies a fuel to an internal combustion engine. The fuel supply device 1 is mounted on a vehicle, such as a motor vehicle and a marine vessel, and supplies a fuel to the internal combustion engine as a power source of the vehicle. The fuel supply device 1 in this embodiment is mounted on a road motor vehicle. The fuel supply device 1 supplies a fuel to a Diesel engine which uses a diesel fuel as the fuel.

The fuel supply system 1 has a fuel tank 2. The diesel fuel as a liquid fuel is accumulated in the fuel tank 2. The fuel supply device 1 has a common-rail 3 as a fuel distribution pipe attached on the internal combustion engine. The fuel supply device 1 pressurizes and supplies the fuel to the common-rail 3. The fuel supply device 1 has a fuel injection valve 4 disposed on a cylinder of the internal combustion engine. The internal combustion engine is a multi-cylinder Diesel engine. The fuel supply device 1 has a plurality of fuel injection valves 4. The common-rail 3 supplies the fuel to the plurality of fuel injection valves 4.

The fuel supply device 1 has a fuel pump 5. The fuel pump 5 has a feed pump (FP) 6 and a high-pressure pump (HP) 7. The feed pump 6 sucks the fuel from the fuel tank 2 and pressurizes it to an intermediate pressure. The high-pressure pump 7 pressurizes the fuel of the intermediate pressure further, and pressurizes it to a high pressure suitable for fuel injection. The high pressure fuel pressurized by the high-pressure pump 7 is supplied to the common-rail 3.

Negative pressure lines 11, 12, and 13 which are being a negative pressure by a suction function by the feed pump 6 are disposed between the fuel tank 2 and the fuel feed pump 5. Pressurized lines 14 and 15 where the intermediate-pressure fuel flows are disposed between the feed pump 6 and the high-pressure pump 7. A pressurized line 16 where the high-pressure fuel flows is disposed between the high-pressure pump 7 and the common-rail 3. The negative pressure lines 11, 12, and 13, and the pressurized lines 14, 15, and 16 are provided with metal pipes, and pressure-resistant hoses, etc.

The fuel supply device 1 has a return line 17 for returning surplus fuel to the fuel tank 2. The return line 17 is used to return the surplus fuel discharged from the common-rail 3 to the fuel tank 2. For example, the fuel discharged from a relief valve disposed on the common-rail 3 is returned to the fuel tank 2 via the return line 17. In addition, the return line 17 is used to return the surplus fuel discharged from the fuel feed pump 5 to the fuel tank 2. For example, the fuel discharged from the fuel feed pump 5 for adjustment of fuel supply or the fuel which leaks from the fuel feed pump 5 is returned to the fuel tank 2 via the return line 17.

The fuel supply device 1 has a first fuel filter 21 and a second fuel filter 22. The first fuel filter 21 is disposed between the fuel tank 2 and the fuel feed pump 5. The first fuel filter 21 is disposed between the negative pressure line 11 and the negative pressure line 12. The first fuel filter 21 filters the fuel which passes through the negative pressure lines 11, 12, and 13. Since the first fuel filter 21 is disposed in the negative pressure lines 11, 12, and 13, it may be also called a negative-pressure filter. The first fuel filter 21 is also called a pre-stage filter or a pre-filter. The first fuel filter 21 may has a fuel heating system which heats a fuel. The first fuel filter 21 may has a water separator which separates water from the fuel and removes water.

The second fuel filter 22 is disposed between the feed pump 6 and the high-pressure pump 7. The second fuel filter 22 is disposed between the pressurized line 14 and the pressurized line 15. The second fuel filter 22 filters the fuel which passes the pressurized lines 14 and 15. Since the second fuel filter 22 is disposed in the pressurized lines 14 and 15, it is also called a pressure filter or a high pressure filter. The second fuel filter 22 is also called the main filter or latter-part filter in the fuel supply device 1.

The fuel supply device 1 has a manual pump 23 for introducing the fuel into the fuel supply device 1 by operation of the user. The manual pump 23 is disposed in the negative pressure lines 11, 12, and 13. The manual pump 23 is disposed between the first fuel filter 21 and the feed pump 6. The manual pump 23 is also called a priming pump. The manual pump 23 is integrally disposed with the second fuel filter 22. The manual pump 23 and the second fuel filter 22 provide the filter assembly 24.

The fuel supply device 1 has an air discharging passage 25 for discharging air from the second fuel filter 22. An end of the air discharging passage 25 is communicated to the second fuel filter 22. This end is communicated in the upper portion of the second fuel filter 22. The other end of the air discharging passage 25 is communicated to the return line 17. In other words, the other end of the air discharging passage 25 is communicated into the fuel tank 2. The air discharging passage 25 is disposed between the second fuel filter 22 and the return line 17. The air discharging passage 25 is disposed between the second fuel filter 22 and the fuel tank 2. The air discharging passage 25 is disposed between a downstream pressurized region from the feed pump 6 and a negative pressure region including the fuel tank 2. The air discharging passage 25 is disposed between the pressurized lines 14 and 15 and the fuel tank 2.

The fuel supply device 1 has a discharge-control valve 26 and an orifice 27. The discharge-control valve 26 is disposed on the air discharging passage 25. The orifice 27 is disposed on the air discharging passage 25. The discharge-control valve 26 and the orifice 27 are disposed in an in-series manner in the air discharging passage 25. The discharge-control valve 26 and the orifice 27 are disposed on the second fuel filter 22. The discharge-control valve 26 and the orifice 27 are disposed on the filter assembly 24.

The discharge-control valve 26 functions as a differential pressure valve which is opened when the fuel supply device 1 is operated, and is closed when the fuel supply device 1 is stopped. The discharge-control valve 26 is closed when a pressure on an upstream side in the air discharging passage 25 is less than an operation pressure indicative of the operation state of the fuel supply device 1, and is opened when the pressure on the upstream side in the air discharging passage 25 is higher than the operation pressure. The discharge-control valve 26 is responsive to a pressure difference of the fuel acting on front and behind thereof, and opens and closes the air discharging passage 25. The discharge-control valve 26 prevents a passing air and/or the fuel through the air discharging passage 25 by closing when the pressure difference is less than a predetermined threshold pressure. The discharge-control valve 26 permits a passing air and/or the fuel through the air discharging passage 25 by opening when the pressure difference is higher than the predetermined threshold pressure.

The discharge-control valve 26 maintains a close condition, when the internal combustion engine is a low rotational speed for starting up. Thereby, the pressurized lines 14 and 15 are maintained at a necessary pressure for fuel supply. The discharge-control valve 26 is opened when the rotational speed of the internal combustion engine is equal to or more than an idle rotational speed or is a rotational speed more than the idle rotational speed. Thereby, it becomes possible to discharge air from the second fuel filter 22. The discharge-control valve 26 is also called an air discharge valve or a differential pressure valve. The discharge-control valve 26 functions also as a one-way valve which prevents reverse flow of air from the air discharging passage 25 to the case 31.

The orifice 27 is easy to pass air and suppresses a passing of a liquid of the fuel. The orifice 27 creates comparatively large flow path resistance and pressure loss to the liquid of the fuel and suppresses a flow amount of the fuel, when the liquid of the fuel flows into the air discharging passage 25. On the other hand, the orifice 27 creates comparatively small flow path resistance and pressure loss, when air flows into the air discharging passage 25, and permits discharge of air. The orifice 27 functions as a fluid element which suppresses discharge of the fuel while permitting discharge of air. The orifice 27 has a cross-sectional area and length which creates sufficiently large flow path resistance and pressure loss with respect to the fuel of a liquid.

In FIG. 2, a cross section of the second fuel filter 22 is mainly illustrated out of the filter assembly 24. A manual operable pump 23 does not appear on this cross section. The drawing shows a regular disposing condition of the filter assembly 24, i.e., the second fuel filter 22. The filter assembly 24 is a configuration near a cylinder. The filter assembly 24 is mounted and fixed to the vehicle to match an axis AX of a cylinder thereof with the gravitational direction. The filter assembly 24 is mounted on the vehicle so that the below-mentioned cup 32 is positioned to a lower side and the below-mentioned cap 33 is positioned to an upper side. The filter assembly 24 may be set positioned on an inclining condition which is not a regular, depending on an inclination of the vehicle or an unsuitable loading works. For example, the filter assembly 24 may be positioned so that the axis AX is inclined a little.

The second fuel filter 22 has a case 31. The case 31 defines and forms a passage where the fuel passes. The case 31 accommodates the below-mentioned element 63 and defines and forms a passage which flows the fuel to pass element 63. The case 31 has the cup 32 disposed as a first case member and the cap 33 disposed as a second case member. The cup 32 and the cap 33 are made of metal, such as made of aluminum or made of an aluminum alloy. The cup 32 and the cap 33 are formed by the die-casting process.

The cup 32 and the cap 33 are able to be engaged and separated. When the cup 32 and the cap 33 are engaged, a passage for the fuel is defined within the case 31. When the cup 32 and the cap 33 are separated, the cup 32 provides a container which is able to accumulate the fuel. The case 31 is separatable into the cup 32 and the cap 33 to exchange the element 63. The cup 32 is fixed to a vehicle in use. The cap 33 is able of be separated from the cup 32.

The cup 32 provides a lower part and a middle part of the case 31 excluding an upper part. The cup 32 has a cylindrical side wall 34. An upper end portion of the side wall 34 provides an opening. A lower end portion of the side wall 34 is closed by a bottom wall 35. The cup 32 is a cylindrical member with a bottom.

The cap 33 provides an upper part of the case 31. The cap 33 functions as a lid which closes an upper opening of the cup 32. The cap 33 has a flange 36, an upper wall 37, and a side wall 38. The flange 36 is an annular member formed to be able to contact on an open end of the cup 32. The upper wall 37 provides a top wall of the case 31. The side wall 38 is a cylindrical section which is positioned in the cup 32 and extends towards the inside of the cup 32 from the open end of the cup 32. The side wall 38 is arranged coaxially with the side wall 34. The side wall 38 is positioned on a radial inside of the side wall 34. At an engaging section of the cup 32 and the cap 33, the side wall 34 provides an outer wall. The side wall 38 provides an inner wall. The side wall 34 is disposed as an outer cylindrical part. The side wall 38 is disposed as an inner cylindrical part arranged inside the outer cylindrical part.

The second fuel filter 22 has an engaging mechanism 41. The engaging mechanism 41 is disposed between the cup 32 and the cap 33. The engaging mechanism 41 is disposed to occupy a part of overlapping range of the side wall 34 and the side wall 38. The engaging mechanism 41 is disposed on a deep portion which is apart from an open end of the cup 32 among the overlapping range.

The engaging mechanism 41 is constituted to enable engagement and separation of between the cup 32 and the cap 33 repeatedly. The engaging mechanism 41 can be provided by various mechanical devices. For example, the engaging mechanism 41 can be provided by a screw-thread device, a bayonet lock mechanism, a snap-fit mechanism, a tightening mechanism by bolts, etc.

The engaging mechanism 41 is provided by the screw-thread device. The engaging mechanism 41 has a female screw 42 and a male screw 43. The female screw 42 is formed on an inner surface of the side wall 34 of the cup 32. The male screw 43 is formed on an outer surface of the side wall 38 of the cap 33. The female screw 42 and the male screw 43 may be tightened or loosened by relatively rotating the cup 32 and the cap 33. In a tightening direction, the cap 33 is tightened into the cup 32 until the flange 36 contacts onto the open end of the cup 32.

The second fuel filter 22 has a sealing mechanism 44. The sealing mechanism 44 is disposed between the cup 32 and the cap 33. The sealing mechanism 44 seals between the cup 32 and the cap 33. The sealing mechanism 44 is disposed to occupy a part of an overlapping range of the side wall 34 and the side wall 38. The sealing mechanism 44 is disposed on a part near the open end of the cup 32 among the overlapping range. The sealing mechanism 44 is disposed on a position nearer to the open end of the cup 32 than the engaging mechanism 41. In other words, the sealing mechanism 44 is disposed between the open end of the cup 32 and the engaging mechanism 41.

The sealing mechanism 44 is constituted to enable engagement and separation of between the cup 32 and the cap 33 repeatedly. The sealing mechanism 44 can be provided by various mechanical devices. For example, the sealing mechanism 44 can be provided by an O-ring seal device, a lip-seal device, a gasket sealing mechanism, etc.

The sealing mechanism 44 is provided by the O-ring seal device. The sealing mechanism 44 has a groove 45 formed on the outer surface of the side wall 38. The sealing mechanism 44 has a cylindrical surface 46 for seals formed on the inner surface of the side wall 34. The sealing mechanism 44 has an O-ring 47 accommodated in the groove 45 and contacts the groove 45 and the cylindrical surface 46.

The second fuel filter 22 has a fuel inlet 51 and a fuel outlet 52. The fuel inlet 51 and the fuel outlet 52 are disposed on the cup 32. The fuel inlet 51 and the fuel outlet 52 are connecting parts for connecting piping. The fuel inlet 51 is connected with the pressurized line 14 and is communicated to the pressurized line 14. The fuel outlet 52 is connected with the pressurized line 15 and is communicated to the pressurized line 15. The fuel inlet 51 introduces the fuel before being filtered by the element 63 into the case 31. The fuel outlet 52 discharges the fuel after being filtered by the element 63.

The second fuel filter 22 has an accommodation portion 53. The accommodation portion 53 accommodates the discharge-control valve 26 and the orifice 27. The accommodation portion 53 is disposed on the cup 32. The accommodation portion 53 is disposed to be positioned below the open end, i.e., the upper end, of the cup 32.

The second fuel filter 22 has the element assembly 61. The element assembly 61 is accommodated in the case 31. The element assembly 61 is formed to be removable to the case 31. The element assembly 61 is held between the cup 32 and the cap 33. The element assembly 61 can be exchanged through the open end of the cup 32, when the cup 32 and the cap 33 are in a separated condition.

The element assembly 61 has a holder 62 and an element 63. The holder 62 supports the element 63 in the case 31. The holder 62 defines a cavity to pass the fuel through the element 63. In addition, the cup 32 may has the center pipe connected with the holder 62.

The element 63 is a filter medium for filtering the fuel. The element 63 is also called a filter element. The element 63 is formed in a cylindrical shape. The element 63 is an axial flow type filter medium which passes the fuel along the axis AX. The element 63 has an upper end surface 64 as a fuel inlet, and the lower end surface 65 as a fuel outlet.

The element assembly 61 defines a dirty side cavity 66 and a clean side cavity 67 within the case 31. The clean side cavity 67 is provided by a passage disposed in the holder 62. The dirty side cavity 66 is communicated to the fuel inlet 51. The clean side cavity 67 is communicated to the fuel outlet 52.

The second fuel filter 22 has the air passage 71. The air passage 71 is a part of the air discharging passage 25. The air passage 71 is disposed in the upper portion of the case 31. The air passage 71 communicates the cavity in the case 31 and the air discharging passage 25 which is outside of the case 31 by extending to penetrate both the cup 32 and the cap 33 and .

The air passage 71 has a capturing passage 72. The capturing passage 72 is a passage to catch and collect air in the case 31. The capturing passage 72 is also called a guide passage which leads air in the case 31 to the accommodation portion 53. The capturing passage 72 extends to surround all around the case at the upper portion of the case 31. The capturing passage 72 is also called an annular passage which extends annularly along all around the case 31. The capturing passage 72 is also called an extension passage which extends out in the circumferential direction from the accommodation portion 53 or a circumferential direction passage. The capturing passage 72 is defined and formed between the cup 32 and the cap 33. The capturing passage 72 is defined and formed between the side wall 34 and the side wall 38. The capturing passage 72 is defined and formed by the inner cylindrical surface 73 disposed on the inner surface of the side wall 34 and the groove 74 disposed on the outer surface of the side wall 38. The capturing passage 72 is disposed between the engaging mechanism 41 and the sealing mechanism 44.

The second fuel filter 22 is designed so that the element 63 is immersed into the fuel. The second fuel filter 22 is designed so that the upper end surface 64 of the element 63 is positioned below the fuel level FL. The fuel level FL is equivalent to the minimum fuel level assumed in a use condition of the second fuel filter 22. The fuel level FL is also called a minimum fuel level. The capturing passage 72 is formed to extend along the minimum fuel level FL. Therefore, the capturing passage 72 extends horizontally in a mounted condition of the second fuel filter 22.

The air passage 71 has a plurality of through holes 77. The through hole 77 is formed to penetrate the side wall 38. The through hole 77 communicates the dirty side cavity 66 in the case 31 and the capturing passage 72. The through hole 77 opens at a lower side end of the cap 33, i.e., above the open end, within the cap 33. The through hole 77 extends horizontally.

The plurality of through holes 77 are disposed to be apart from each other along the circumferential direction. The plurality of through holes 77 are dispersively arranged along the capturing passage 72. The plurality of through holes 77 are dispersively arranged over all around the case 31. The plurality of through holes 77 are distributed almost uniformly without an excessive unevenness along the circumferential direction. As a result, the capturing passage 72 and the cavity in the case 31 are communicated at a plurality of positions in the circumferential direction of the case 31. Thereby, the capturing passage 72 can introduce air from a large range extended in the circumferential direction of the case 31 via the plurality of through holes 77. Specifically, the capturing passage 72 can introduce air from a range covering all around the case 31.

The air passage 71 has a lead-out passage 78 and an outlet passage 79. The outlet passage 79 is formed in the accommodation portion 53. The outlet passage 79 is communicated to the return line 17 and the fuel tank 2 via the accommodation portion 53. The lead-out passage 78 is formed on the side wall 34. The lead-out passage 78 is formed to open to a limited angular range in the circumferential direction of the cup 32. The lead-out passage 78 extends in the radial direction. The lead-out passage 78 communicates the capturing passage 72 and the outlet passage 79. The lead-out passage 78 and the outlet passage 79 provide a passage which penetrates the side wall 34.

The through hole 77, the capturing passage 72, the lead-out passage 78, and the outlet passage 79 are disposed on the upper portion of the case 31. The through hole 77, the capturing passage 72, the lead-out passage 78, and the outlet passage 79 are disposed on the upper portion of the cup 32. The through hole 77, the capturing passage 72, the lead-out passage 78, and the outlet passage 79 are disposed near the open end of the cup 32. This arrangement makes it possible to make the minimum fuel level FL high in the case 31. In other words, this arrangement makes it possible to reduce an air amount in the case 31.

The through hole 77 is arranged along the minimum fuel level FL. An upper edge of the through hole 77 is formed to coincide with the minimum fuel level FL. In a mounted condition of the second fuel filter 22, the upper edge of the capturing passage 72 is positioned in the same height as or higher than the upper edge of the through hole 77. An upper edge of the lead-out passage 78 is positioned in the same height as or higher than an upper edge of the capturing passage 72. An upper edge of the outlet passage 79 is positioned in the same height as or higher than the upper edge of the lead-out passage 78. The height of these upper edges contributes to catch air which reached below the minimum fuel level FL.

The case 31 defines and forms the capturing passage 72 which extends in the circumferential direction along the upper portion of the case 31. The case 31 defines and forms a plurality of through holes 77 which are dispersively arranged along the capturing passage 72 and communicate the inside of the case 31 and the capturing passage 72. The case 31 defines and forms the lead-out passage 78 which extends out from a part of the capturing passage 72.

The plurality of through holes 77 and the capturing passage 72 certainly provide communications of the lead-out passage 78 and the cavity in the case 31. For example, even if the positions of the cup 32 and the cap 33 in the circumferential direction shifts relatively, the lead-out passage 78 is certainly communicated with the cavity in the case 31 via the plurality of through holes 77 and the capturing passage 72.

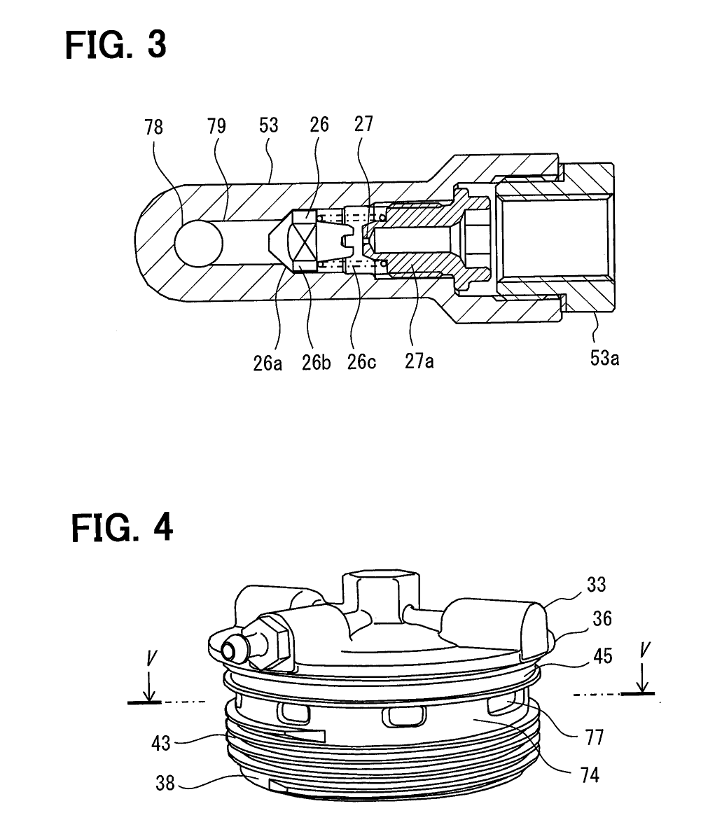

In FIG. 3, the accommodation portion 53 is defines and forms the outlet passage 79. A bushing 53a is disposed in the accommodation portion 53. A piping which provides the air discharging passage 25 is connected to the bushing 53a. The accommodation portion 53 provides the outlet part of the air discharging passage 25 including the lead-out passage 78. The outlet part is disposed in the cup 32. This arrangement enables free removal of the cap 33.

The discharge-control valve 26 and the orifice 27 are accommodated in the accommodation portion 53. The discharge-control valve 26 has a valve seat 26a, a valve element 26b, and a spring 26c. The valve seat 26a is stationary formed on the accommodation portion 53. In the accommodation portion 53, the valve element 26b is accommodated in the axial direction. The spring 26c pushes the valve element 26b in a valve closing direction.

The orifice 27 is disposed in the bolt 27a which is attached on an inside of the accommodation portion 53. The orifice 27 is provided by the restriction passage with a small diameter.

As shown in FIG. 4, the groove 74 defining the capturing passage 72 is disposed between the groove 45 for the O-ring 47 and the male thread 43 for the engaging mechanism 41. A radial inside surface of the groove 45 spreads as the same cylindrical outer surface of the outer cylindrical surface with same the radial inside side of a groove 45, i.e., bottom surface, and trough portion of the external thread 43.

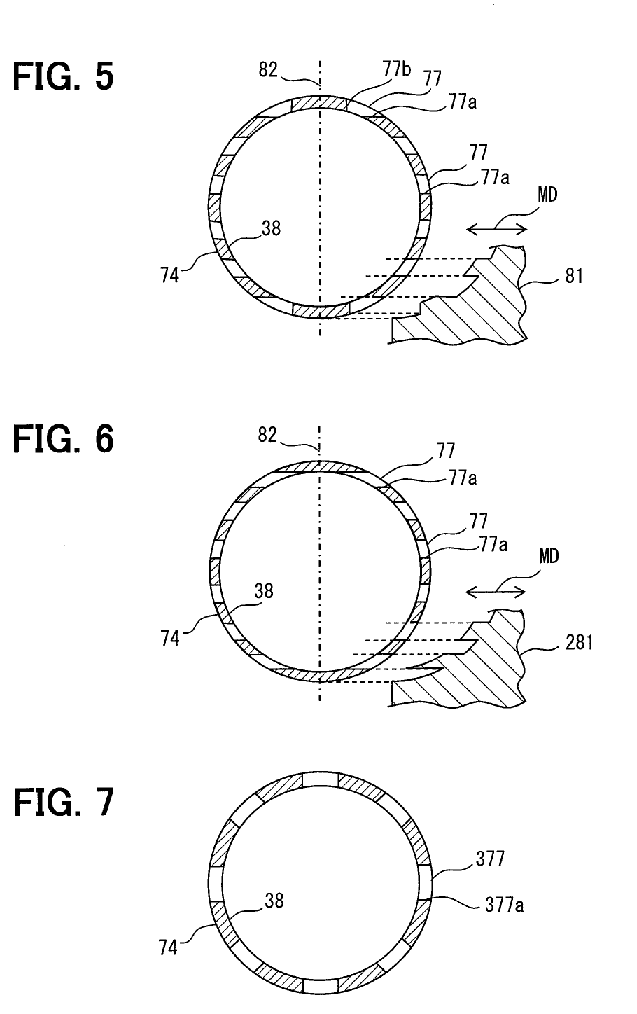

As shown in FIG. 5, a plurality of through holes 77 are formed on the side wall 38. In the drawing, a part of the molding die 81 is illustrated. In the die-casting process, a plurality of through holes 77 is defined and formed by surfaces formed by the molding die 81. The molding die 81 is a molding die of a two-piece separatable type which is separatable at a die dividing plane 82. Moving direction MD of the molding die 81 is perpendicular to the die dividing plane 82.

In the illustrated embodiment, the through hole 77 is defined by only the surfaces 77a and 77b which can be formed by the molding die 81. The through hole 77 is defined by only the surface which allows to remove the molding die 81. The surface 77a is a surface spreads along a moving direction MD. In order to remove the molding die 81, the surface 77a may incline to face outwardly a little. The surface 77b is a surface facing in the moving direction MD.

In this embodiment, the plurality of through holes 77 are disposed on the side wall 38 in a cylindrical shape. The plurality of through holes 77 are formed by the molding die 81 in the die-casting process. Accordingly, the plurality of through holes 77 can be formed easily.

Returning to FIG. 1, the fuel supply device 1 is operated as explained below. When starting the internal combustion engine, clanking of the internal combustion engine is carried out. Simultaneously, the fuel pump 5 is driven. When the feed pump 6 is operated, the feed pump 6 sucks the fuel from the fuel tank 2. The fuel passes the first fuel filter 21 and the manual pump 23, and reaches the feed pump 6. The fuel is filtered in the first fuel filter 21. The manual pump 23 is operated after the fuel supply device 1 is assembled, and it is used to introduce the fuel in the fuel supply device 1 from the fuel tank 2.

The feed pump 6 supplies the fuel to the high-pressure pump 7. The fuel passes the second fuel filter 22 and reaches the high-pressure pump 7. In the second fuel filter 22, the fuel is filtered again. The high-pressure pump 7 pressurizes the fuel to a high-pressure suitable for injection, and supplies the fuel to the common-rail 3. The common-rail 3 supplies the fuel to the plurality of fuel injection valves 4. The fuel injection valve 4 injects the fuel to a corresponding cylinder.

Thereby, the internal combustion engine starts and the internal combustion engine is operated continuously. The internal combustion engine can be stopped by stopping the fuel pump 5. Surplus fuel in the fuel supply device 1 is returned to the fuel tank 2 via the return line 17.

In FIG. 2, the second fuel filter 22 filters the fuel in the pressurized lines 14 and 15. In the cap 33 of the second fuel filter 22, a cavity in a bag shape, which has a bottom communicated to the fuel passage and a top closed, is defined and formed. Air may be accumulated in this cavity. Air may be accumulated in this cavity during the fuel supply device 1 is operated.

When the element assembly 61 is exchanged, the cap 33 is removed from the cup 32. At this time, the cap 33 moves towards above the cup 32 by the engaging mechanism 41. When the cap 33 is separated, the element assembly 61 is exposed within the open end of the cup 32. The element assembly 61 is extracted upwardly. The fuel remains within the cup 32 over both process for removing the cap 33 and process for extracting the element assembly 61.

Next, the new element assembly 61 is inserted into the cup 32. In addition, the cap 33 is attached onto the cup 32 to close the open end of the cup 32.

At this time, the cap 33 is thrust into the cup 32 towards the bottom from the top. The amount of screwing the cap 33 is prescribed by contacting the flange 36 onto the open end of the cup 32. Even after being re-attached with the cap 33, air accumulated within the case 31.

If the fuel pump 5 is driven in the condition that air exists in the case 31, the fuel in the intermediate pressure is supplied to the second fuel filter 22. If the inside of the case 31 is pressurized to the intermediate pressure, the discharge-control valve 26 is opened. In a case that air flows in the lead-out passage 78 and the outlet passage 79, the orifice 27 permits to pass air. The orifice 27 permits air flow of comparatively large amount. In a case that the fuel flows in the lead-out passage 78 and the outlet passage 79, the orifice 27 demonstrates high flow path resistance to the fuel and suppresses the discharge of the fuel.

In a case that air exists below the upper edge of one through hole 77 among the plurality of through holes 77, air flows out to the capturing passage 72 through the through hole 77. Air reaches to the lead-out passage 78 through the capturing passage 72. Since the capturing passage 72 extends long along the circumferential direction, even if the circumferential direction position of the cap 33 shifts with respect to the position of the lead-out passage 78, the air passage 71 is formed certainly.

Air in the case 31 is discharged until the fuel level in the case 31 becomes higher than the minimum fuel level FL. Since the minimum fuel level FL is set above the upper end surface 64 of the element 63, entering of air to the element 63 is suppressed. If the fuel level is changed, air will flow into the capturing passage 72 through some through holes 77. Air flows to the lead-out passage 78 through the capturing passage 72, and is discharged. As a result, the fuel level in the case 31 shifts to exceed the minimum fuel level FL.

According to the embodiment explained above, the improved second fuel filter 22 is provided. The second fuel filter 22 can discharge air from the large range in the case 31. The second fuel filter 22 can discharge air from all around the case 31.

Even if it is a case where the cup 32 and the cap 33 have the side wall 34 and the side wall 38 which are arranged in a double wall manner, the second fuel filter 22 can form the air passage 71 certainly. Even if the cup 32 and the cap 33 may shift in the circumferential direction, the lead-out passage 78 can communicate to the inside of the case 31.

Stationary piping connected to the second fuel filter 22 is connected only to the cup 32. That is, a piping providing the pressurized line 14 is connected to the connecting part disposed in the cup 32 in order to communicate to the fuel inlet 51. A piping providing the pressurized line 15 is connected to the connecting part disposed on the cup 32 in order to communicate to the fuel outlet 52. In addition, a piping providing the air discharging passage 25 is connected to the connecting part (bushing 53a) of the accommodation portion 53 in order to communicate to the air passage 71. The second fuel filter 22 can remove the cap 33 while maintaining the stationary piping in connected condition. In other words, the element assembly 61 can be exchanged, while maintaining the stationary piping in connected condition. In addition, air can be discharged so that the minimum fuel level FL may be positioned in comparatively high position in the case 31.

The plurality of through holes 77 can be formed by a die-casting process.

Therefore, the second fuel filter 22 with an improved air discharging performance can be provided at low cost. In addition, the plurality of through holes 77 can be formed by a two-piece separatable type molding die 81.

### Second Embodiment

This embodiment is one of modifications based on a basic form provided by the preceding embodiment. In the preceding embodiment, as shown in FIG. 5, the through hole 77 having the surface 77 is used. Alternatively, as shown in FIG. 6, in this embodiment, the through hole 77 is defined and formed by only a surface 77a which spreads along a moving direction MD of a molding die. The molding die 281 forms the through hole 77 by molding surface which spreads along the moving direction MD.

### Third Embodiment

This embodiment is one of modifications based on a basic form provided by the preceding embodiment. In the preceding embodiment, as shown in FIG. 5 or 6, the through hole 77 is formed by using the molding die 81 and 281. Alternatively, a through hole may be formed without using a molding die.

As shown in FIG. 7, in this embodiment, a plurality of through holes 377 are also disposed on the side wall 38. The plurality of through holes 377 are radially extended to the side wall 38. The through hole 377 can be formed with a drill from the radial outside of the side wall 38.

### Other Embodiments

The disclosure in this description is not restricted to the illustrated embodiment. The disclosure includes the illustrated embodiments and modifications by a person skilled in the art based on the illustrated embodiments. For example, disclosure is not limited to the component and/or the combination of the components shown in the embodiments. The disclosure can be carried out with various combinations. The disclosure may use additional parts which can be added to the embodiments. The disclosure may contain modifications in which component and/or element of the embodiments are removed. The disclosure may contain modifications in which component and/or element of the embodiments are exchanged or combined. Technical scope of disclosure is not limited to the embodiments. It should be understood that some disclosed technical scope may be shown by description in the scope of claim, and contain all modifications which are equivalent to and within description of the scope of claim.

In the preceding embodiment, the capturing passage 72 is an annular passage surrounding all periphery of a cavity in the case 31. Alternatively, the capturing passage 72 may be formed to extend along a part of perimeter of the cavity in the case 31. For example, the capturing passage 72 may be disposed only on a half round part of the case 31. Also in this case, the capturing passage 72 is formed along the minimum fuel level FL in the case 31. In addition, the plurality of through holes 77 and 377 are disposed along the capturing passage 72.

In the preceding embodiment, the plug for providing the orifice 27 is disposed in the air discharging passage 25. Alternatively, a small passage which functions as the orifice 27 may be disposed on the air discharging passage 25 or components, such as the discharge-control valve 26. In addition, in the preceding embodiment, the discharge-control valve 26 and the orifice 27 are disposed on the cup 32 of the second fuel filter 22. Alternatively, the discharge-control valve 26 and/or the orifice 27 may be disposed as separated components from the second fuel filter 22.

In the preceding embodiment, the cup 32 and the cap 33 are metal. Alternatively, the cup 32 and the cap 33 may be made of resin.

In the preceding embodiment, the air passages 71 (77, 72, 78, 79) are arranged in a horizontally side by side manner when in a usual mounting condition of the second fuel filter 22. Alternatively, an upper edge of the plurality of passages 77, 72, 78, and 79 which constitute the air passage 71 may be arranged to become high gradually in this order. In addition, the latter passage, e.g., passages 78 and 79, may be arranged above the preceding passage. Such structure makes air caught in the capturing passage 72 easy to reach the orifice 27. For example, the outlet passage 79 may be positioned above the open end of the cup 32 by disposing the accommodation portion 53 above the embodiment illustrated.

In the preceding embodiment, the side wall 34 of the cup 32 is disposed as the outer cylindrical part, and the side wall 38 of the cap 33 is disposed as the inner cylindrical part. Alternatively, the side wall 34 of the cup 32 may be disposed as the inner cylindrical part, and the side wall 38 of the cap 33 may be disposed as the outer cylindrical part. In this case, the through hole 77 is formed on the side wall 34 as the inner cylindrical part.

In the preceding embodiment, the screw-thread device is adopted as the engaging mechanism 41. Alternatively, various mechanical engaging mechanisms may be used. For example, it is possible to adopt a center-bolt engaging mechanism which tightens the cup 32 and the cap 33 by a center bolt arranged on a center. In addition, it is possible to adopt a clamp connection device which tightens the cup 32 and the cap 33 by a tightening clamp attached on an outside of them.

In the preceding embodiment, the element 63 is an axial flow type filter medium. Alternatively, a filter medium in which a fuel flows in a radial direction may be adopted.

What is claimed is:

1. A fuel filter comprising:
an element which filters a fuel; and
a case which accommodates the element, and defines and forms a passage for flowing the fuel to pass through the element, wherein
the case is separatable into a cup and a cap to exchange the element, and forms a capturing passage which extends in a circumferential direction along an upper portion of the case, a plurality of through holes which are dispersively arranged along the capturing passage and communicates an inside of the case and the capturing passage, and a lead-out passage which extends out from a part of the capturing passage.

2. The fuel filter claimed in claim 1, further comprising:
a discharge-control valve which is disposed on an air discharging passage including the lead-out passage, and is closed when a pressure in the air discharging passage is less than an operation pressure indicative of operation state of a fuel supply device, and is opened when a pressure in the air discharging passage is higher than the operation pressure; and
an orifice which is disposed on the air discharging passage, and is easy to pass air, and suppresses a passing of a liquid of the fuel.

3. The fuel filter claimed in claim 1, wherein
the capturing passage is defined and formed between the cup and the cap.

4. The fuel filter claimed in claim 1, further comprising:
an engaging mechanism which connects the cup and the cap; and a sealing mechanism which seals between the cup and the cap.

5. The fuel filter claimed in claim 4, wherein
a capturing passage is disposed between the engaging mechanism and the sealing mechanism.

6. The fuel filter claimed in claim 1, wherein
the cup includes;
a fuel inlet which introduces the fuel before being filtered by the element;
a fuel outlet which discharges the fuel after being filtered by the element; and
an outlet part of the air discharging passage includes the lead-out passage.

7. The fuel filter claimed in claim 1, wherein
the cup has all of a plurality of connecting parts for connecting stationary piping for the fuel, and wherein
the cap is separatable from the cup without separating the stationary piping.

8. The fuel filter claimed in claim 1, wherein
the case includes:
a side wall as an outer cylindrical part;
a side wall as an inner cylindrical part arranged inside to the outer cylindrical part;
an engaging mechanism which connects the outer cylindrical part and the inner cylindrical part; and
a sealing mechanism which seals between the outer cylindrical part and the inner cylindrical part, and wherein
the capturing passage is formed between the outer cylindrical part and the inner cylindrical part, and is formed between the engaging mechanism and the sealing mechanism, and wherein
the through hole is formed to penetrate the inner cylindrical part, and wherein
the lead-out passage is formed to penetrate the outer cylindrical part.

9. The fuel filter claimed in claim 1, wherein
the through hole is defined and formed by a surface formed by a molding die.
